(19) United States
(12) Patent Application Publication
(10) Pub. No.: US 2025/0148363 A1
(43) Pub. Date: May 8, 2025

(54) TECHNIQUES FOR COMPUTING PERFORMANCE METRICS FOR MULTIOUTPUT-MULTILABEL MACHINE LEARNING MODELS

(71) Applicant: Oracle International Corporation, Redwood Shores, CA (US)

(72) Inventors: Antariksha Bhaduri, Bengaluru (IN); Amit Kumar Prajapati, Kolkata (IN); Furqan Abdul Samad Shaikh, Bengaluru (IN)

(73) Assignee: Oracle International Corporation, Redwood Shores, CA (US)

(21) Appl. No.: 18/767,046

(22) Filed: Jul. 9, 2024

(30) Foreign Application Priority Data
Nov. 7, 2023 (IN) 202341075899

(51) Int. Cl. G06N 20/00

(52) U.S. Cl. CPC G06N 20/00

(57) ABSTRACT

The present disclosure relates to machine learning (ML) models, and more particularly to novel techniques for computing performance metrics for Multioutput-Multilabel ML models. Novel techniques are described for computing the performance metrics in a parallel and distributed without having to store the entire dataset for which metrics are to be computed in the memory of a data processing system. Novel data structures are provided for performing the computations.

### CROSS-REFERENCE TO RELATED APPLICATION

This application claims priority to India Provisional Application No. 202341075899, filed Nov. 7, 2023 and titled “TECHNIQUES FOR COMPUTING PERFORMANCE METRICS FOR MULTIOUTPUT-MULTILABEL MACHINE LEARNING MODELS,” the contents of which are incorporated herein by reference in their entirety.

### FIELD

The present disclosure relates generally to machine learning (ML), and more particularly, though not necessarily exclusively, to novel techniques for computing performance metrics for multioutput-multilabel ML. Novel techniques are described for computing the performance metrics using a micro value and a macro value.

### BACKGROUND

Measuring performance for machine-learning, such as for machine-learning models or data thereof, etc., is of a great importance as degradation of performance can have direct impact in decision making, user experience, productivity, and the like. In order to track machine-learning performance, relevant data, which may include prediction output and ground truth, may be required. When such data is available, there are different measures available which can track different aspects, such as accuracy, bias, etc., of machine-learning.

Traditionally, supervised models have been used in various industries to perform different tasks such as classifying characteristics, predicting approximate measures, and the like. Over time, as the computational power of systems has increased along with discovery of more sophisticated algorithms, the use of machine-learning has increased. In some examples, machine-learning models may evolve from earlier binary classifications into more advanced classifications. With the evolution of these models, the need to calculate metrics to track a corresponding performance has also increased. No existing and/or standard library can compute and/or track metrics for multioutput-multilabel machine-learning.

### BRIEF SUMMARY

The present disclosure relates generally to machine-learning, and more particularly to novel techniques for computing performance metrics for multioutput-multilabel machine-learning. Novel techniques are described for computing the performance metrics using a micro value and a macro value. Novel data structures are provided for performing the computations.

Various embodiments are described herein, including methods, systems, non-transitory computer-readable storage media storing programs, code, or instructions executable by one or more processors, and the like. Some embodiments may be implemented by using a computer program product, comprising computer program/instructions which, when executed by a processor, cause the processor to perform any of the methods described in the present disclosure.

According to certain embodiments, a method can be used to generate one or more performance metrics for a multi-output, multi-label machine-learning (ML) model. The method can include receiving data about the multi-output, multi-label ML model. The data can include predictions made by the multi-output, multi-label ML model and truth data associated with the predictions, and the truth data can include information about a ground truth of corresponding predictions of the predictions. The method can include determining, for each class and each output of the predictions of the multi-output, multi-label ML model and based on the truth data, false negative values (FN), false positive values (FP), true negative values (TN), and true positive values (TP). The method can include generating a micro value for a performance metric based on aggregated values associated with the FN, the FP, the TN, and the TP. The method can include generating a macro value for the performance metric based on averaged values of the FN, the FP, the TN, and the TP. The method can include outputting the performance metrics for controlling the multi-output, multi-label ML model based at least in part upon the performance metrics.

In some embodiments, the predictions can include a set of outputs. For each output included in the set of outputs, the multi-output, multi-label ML model can select a class prediction for the output from a set of classes associated with the output. The set of classes for an output included in the set of outputs can be different from a set of classes associated with one or more other outputs included in the set of outputs.

In some embodiments, receiving the data about the multi-output, multi-label ML model can include receiving data for each of a set of datapoints in which the data for each datapoint included in the set of datapoints can include (i) information included in the predictions and identifying a class predicted by the multi-output, multi-label ML model for each output included the set of outputs and (ii) information included in the truth data and identifying a ground truth class for each output included the set of outputs. Additionally or alternatively, receiving the data can include partitioning the received data.

In some embodiments, partitioning the received data can include (i) partitioning the data received for the multi-output, multi-label ML model into at least a first partition and a second partition in which the first partition can include data for a first set of datapoints from the set of datapoints and the second partition can include data for a second set of datapoints from the set of datapoints, (ii) computing, by a first processing system, a first confusion matrix and a first set of values based upon the first partition received by the first processing system, (iii) computing, by a second processing system, a second confusion matrix and a second set of values based upon the second partition received by the second processing system, and (iv) generating a merged confusion matrix by merging the first confusion matrix and the second confusion matrix.

In some embodiments, the method can additionally include using the merged confusion matrix to determine the FN, the FP, the TN, and the TP for each output and for each class.

In some embodiments, at least a portion of the computing performed by the second processing system can be performed substantially contemporaneously with respect to the computing performed by the first processing system.

In some embodiments, generating the micro value can include calculating the micro value for the metric by aggregating, by class, the FN, the FP, the TN, and the TP. Additionally or alternatively, generating the macro value can include (i) calculating metric values for each class of each output using the FN, the FP, the TN, and the TP and (ii) averaging the metric values.

The foregoing, together with other features and embodiments will become more apparent upon referring to the following specification, claims, and accompanying drawings.

### BRIEF DESCRIPTION OF THE DRAWINGS

FIG. 1 is a block diagram of a computing environment that can facilitate techniques for computing performance metrics of a multi-output, multi-label machine-learning model, according to at least one embodiment.

FIG. 2 is a distributed environment for partitioning data for facilitating computing performance metrics for multi-output, multi-label ML models, according to at least one embodiment.

FIG. 3 is a flowchart of a process for computing performance metrics of a multi-output, multi-label machine-learning model, according to at least one embodiment.

FIG. 4 is a flowchart of a process for computing performance metrics of a multi-output, multi-label machine-learning model using partitioning, according to at least one embodiment.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

The present disclosure relates to machine learning (ML), such as ML models, data thereof, etc., and more particularly to novel techniques for computing performance metrics, such as by computing a micro value and/or a macro value, for a multioutput-multilabel ML. Additionally, novel techniques are described for computing the performance metrics in a parallel and distributed without having to store the entire dataset for which metrics are to be computed in the memory of a data processing system. Novel data structures are provided for performing the computations.

The present disclosure describes techniques for analyzing and computing performance metrics for multi-output, multi-label ML, such as multi-output, multi-label ML classification models, on large data ensembles. In certain implementations, an algorithm can perform a single pass over partitioned and distributed data to produce the result. This algorithm can form a basis for computing performance metrics such as accuracy, precision, recall, and other suitable metrics for ML observability.

As used herein, a false negative (FN), or FN value, is an outcome in which a model, such as the multi-output, multi-label ML model, incorrectly predicts a negative class. As used herein, a false positive (FP), or FP value, is an outcome in which the model incorrectly predicts a positive class. As used herein, a true negative (TN), or TN value, is an outcome in which the model correctly predicts the negative class. As used herein, a true positive (TP), or TP value, is an outcome in which the model correctly predicts a positive class. As used herein, precision, or a precision metric, is an ability of a classifier, such as the model, not to label as positive a sample that is negative. As used herein, recall, or a recall metric, is an ability of the classifier to identify all positive samples.

Measuring performance for ML, such as for ML models, is of great importance as degradation of performance can have direct impact in decision making, user experience and productivity. In order to track ML performance, relevant data, which includes prediction output and ground truth, are used. In examples in which such data is available, there are different measures available which track different aspects of ML, such as, how accurate the model is in making a prediction, how specific the model is, etc.

The present disclosure describes techniques for calculating one or more performance metrics for a specific type of ML model, namely multioutput-multilabel ML models. Currently used ML monitoring libraries and ML platforms do not support the metric types described in this disclosure for multioutput-multilabel ML models. Libraries developed by cloud service providers also do not provide this functionality. One of the most widely used libraries for ML model metric generation (Scikit-learn) expressly mentions in their error log that they do not support multioutput-multilabel ML models performance metrics.

Some examples of metrics that can be computed include accuracy, precision, and recall. Other suitable performance metrics can be computed or otherwise tracked for multioutput-multilabel ML models. Classification ML Models can be categorized into at least four different classes based at least in part on the type of prediction they generate. The type of prediction can be categorized by considering two main criteria:
Cardinality of the output column—the cardinality corresponds to the number of distinct elements that can be present for the output column category. For example, a model predicting only pass or fail has a cardinality of 2.
Number of output column—an output column can correspond to a label. For example, models with more than one label may have a number of output columns greater than one.

Based on the foregoing, the following categorization illustrated in TABLE 1 is possible.

TABLE 1

| | | Output | Output | |
|---|---|---|---|---|
| | Model | Column | Column | |
| MODEL | Category | Cardinality | Count | Example |
| A | Binary | 2 | 1 | Predicting true or false or pass or fail. For |
| | Classifier | | | example, predict if a movie is comedy or not. |
| B | Multi-class | >2 | 1 | Predicting a movie genre such as horror, comedy, |
| | Classifier | | | or sci-fi. |
| C | Multi-label | 2 | >1 | Predicting probabilities of categories a movie can |
| | Classifier | | | be. For example, a movie can be both a comedy |
| | | | | and sci-fi or the movie can be fantasy, horror, and |
| | | | | drama, etc. So the output can include (1, 1, 0) for |
| | | | | (comedy, sci-fi, horror). |
| D | Multioutput- | >2 | >1 | Predicting how much of a specific type of content |
| | Multilabel | | | a movie has. For example, a movie may be (Low, |
| | | | | High, None) for (comedy, sci-fi, horror). |

While there are performance metrics available for models A and B, and some limited ones for model C, model D is new with no available metrics in available libraries.

For calculating a performance metric for a multi-output, multi-label model, a macro-macro and micro-micro technique can be used. A macro averaging technique and a micro aggregating technique can be described as:
Micro is concerned with the study of individual classes. For example, a firm's micro average examines personal goods' price and market structure.
Macro is concerned with totals and/or averages, which can include, as an example, economy-wide phenomena such as unemployment, price levels of economic growth, and gross domestic product or GDP using macro average.

The difference between macro values and micro values may be that macro values give equal weight to each category while micro values give equal weight to each sample. If there are the same number of samples for each class, macro values and micro values may provide approximately the same score.

Certain aspects and features of the present disclosure relate to a modified macro-macro and micro-micro algorithm. As described herein, the modified macro-macro and micro-micro algorithm is used in which each output of a set of outputs can be iteratively macro averaged and micro aggregated. The techniques described herein can also be used for cases in which the output columns are categorical, are continuous, or a hybrid thereof. For continuous prediction features, the ground truth may also be continuous.

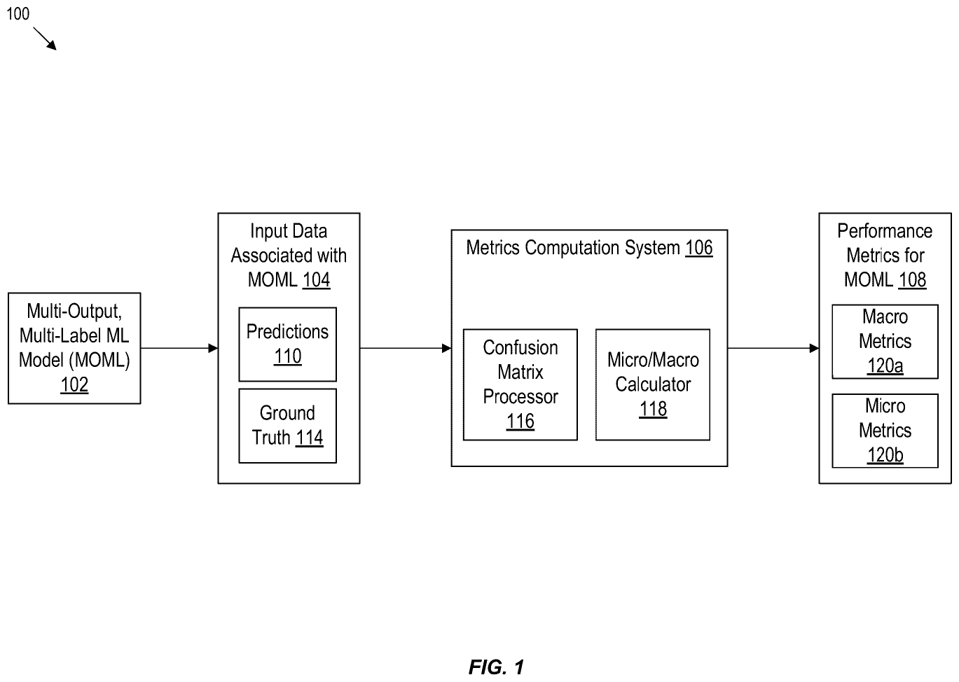

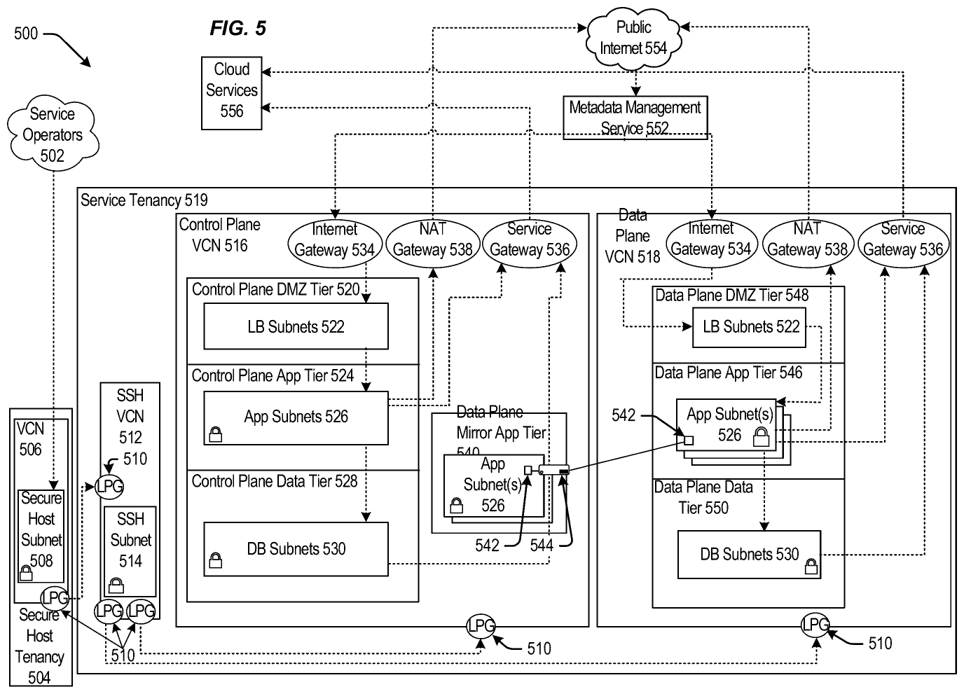

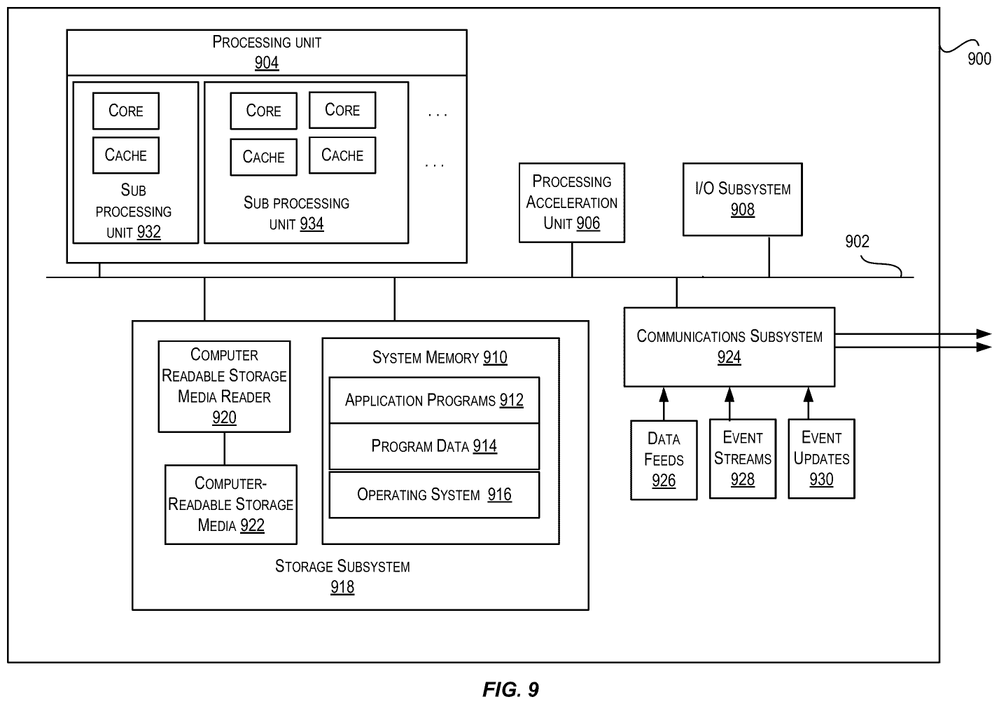

FIGS. 1-4 describe examples and embodiments related to an architecture, techniques, and a computing environment that can be used to facilitate techniques for computing performance metrics for multi-output, multi-label machine learning. FIGS. 5-8 depict examples of architectures for implementing cloud infrastructures for providing one or more cloud services, where the infrastructures may incorporate teachings described herein. FIG. 9 depicts a block diagram illustrating an example of a computer system or device, according to at least one embodiment.

### Novel Architectures and Processes for a Metrics Management System

FIG. 1 is a block diagram of a computing environment 100 that can facilitate techniques for computing performance metrics of a multi-output, multi-label machine-learning (ML) model, according to at least one embodiment. As illustrated in FIG. 1, the computing environment 100 can include a multi-output, multi-label ML model 102, input data 104, a metrics computation system 106, and performance metrics 108, though the computing environment 100 may include additional, alternative, or fewer components, subsystems, or the like.

The multi-output, multi-label ML model 102 may be configured to make predictions about data in which the predictions involve multiple outputs and multiple classes. The outputs may each involve multiple different classes from which the multi-output, multi-label ML model 102 can select as a prediction. For example, a first output may have two, three, four, or more than four classes from which the multi-output, multi-label ML model 102 can select, and a second output may have two, three, four, or more than four classes from which the multi-output, multi-label ML model 102 can select. The first output is different from the second output, and classes associated with the first output can be different from classes associated with the second output.

The multi-output, multi-label ML model 102 can receive a set of input data and can make a set of predictions such as predictions 110. The predictions can include selections of classes for each possible output of a set of outputs associated with the set of input data. Additionally or alternatively, ground truth 114 associated with the predictions 110 can be included in the input data 104. The ground truth 114 can be or include ground truth data for the classes. For example, the ground truth 114 can include the correct predictions for the set of outputs. The input data 104 can include the ground truth 114 and the predictions 110, and the input data 104 can be provided, such as via a stream, to the metrics computation system 106.

The metrics computation system 106 may include a confusion matrix processor 116 and a micro/macro calculator 118, though additional, alternative, or fewer suitable components, services, models, and the like are possible to include in the metrics computation system 106. The metrics computation system 106 can receive the input data 104 and can provide at least a portion of the input data 104 to the confusion matrix processor 116. The confusion matrix processor 116 can receive the input data 104 and can generate a confusion matrix based on the input data 104. For example, the confusion matrix processor 116 can initialize a matrix to all zeros and can update the initialized matrix with false negative values (FN), false positive values (FP), truc negative values (TN), and true positive values (TP). The confusion matrix can be provided to the micro/macro calculator 118 to facilitate calculation of a performance metric, or any values associated therewith.

The micro/macro calculator 118 can perform one or more operations on received data. In some examples, the micro/macro calculator 118 can receive the confusion matrix, which may include some calculated values such as FN, FP, TN, TP, and the like. The micro/macro calculator 118 can use the calculated values, the confusion matrix, or the like to generate micro values, to generate macro values, and the like. For example, the micro/macro calculator 118 can use FN, FP, TN, and TP to calculate micro values, to calculate macro values, and the like. In some embodiments, micro values may be or include performance metrics of a particular output of the set of outputs, and macro values may be or include performance metrics across all outputs of the set of outputs. Stated differently, macro values may give equal weight to each output while micro values may give equal weight to each class of a respective output.

The micro values and/or the macro values can be output by the metrics computation system 106 and can be, or can be used to generate, the performance metrics 108. For example, the micro values and/or the macro values can be further used, for example by the metrics computation system 106 or other suitable computing system, to generate macro metrics 120a and/or micro metrics 120b. In other examples, the micro values and/or the macro values may be the micro metrics 120b and/or the macro metrics 120a, respectively. Some examples of metrics for the performance metrics 108 can include precision, accuracy, and recall, though other suitable metrics may be included in the performance metrics 108.

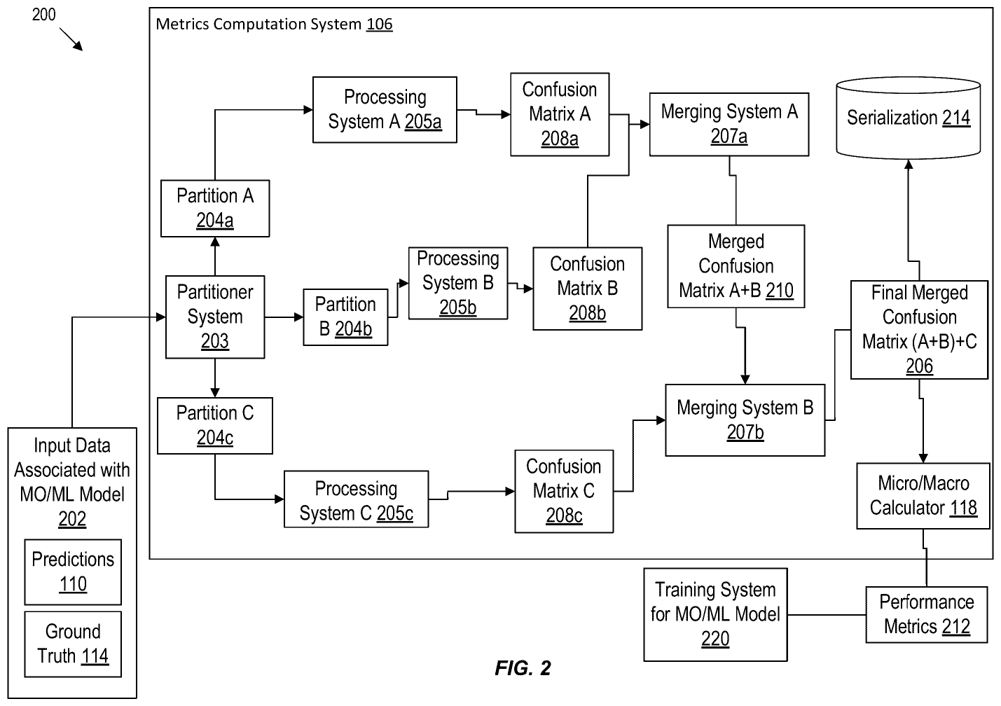

FIG. 2 is a distributed environment 200 for partitioning data for facilitating computing performance metrics for multi-output, multi-label ML models, according to at least one embodiment. Along with the ability to calculate the performance metrics, novel techniques are also described for performing the computation a parallel and distributed manner. A novel technique that is implemented using a parallel distributed architecture, such as the distributed environment 200, is provided. As a result of the novel computation techniques described herein, in certain implementations, the computation can be performed on any arbitrary amount/size of data (e.g., streaming data) and can be scaled both vertically and horizontally.

An example of a distributed architecture that enables the performance metrics to be computed in a parallel manner on large amounts of data is illustrated as the distributed environment 200 in FIG. 2. As illustrated in the FIG. 2, there may be multiple distributed processing nodes that are configured to perform processing in parallel. The input data 202 may be partitioned, such as by a partitioner system 203, in multiple partitions (or chunks), such as partition A 204a, partition B 204b, and partition C 204c (though more than three or less than three partitions are possible) based upon the number of available processing nodes or processing systems for processing partitions. The distributed environment 200 is illustrated as including processing system A 205a, processing system B 205b, and processing system C 205c, though more than three or less than three processing systems are possible for the distributed environment 200.

The input data 202 may include multiple data points, and for each data point, predictions made by a multi-output, multi-label ML model for the data point and actuals (ground truth) corresponding to the predictions made by the multi-output, multi-label ML model. Accordingly, the input data 202 may include multiple data points (potentially large numbers) and the following for each data point in which the predicted value and the actual value for an output is a class from a class set associated with that output:

```
(Data point,
  {(Output 1 Predicted Value, Output 1 Actual Value)},
  {(Output 2 Predicted Value, Output 2 Actual Value)},
  . . .
  {(Output “n” Predicted Value, Output “n” Actual Value)}
).
```

In certain use cases, the input data 202 may be received as part of a data stream.

As illustrated in FIG. 2, the input data 202 can be partitioned by the partitioner system 203 into three partitions, with each processing system receiving one partition. For example, processing system A 205a receives partition A 204a, processing system B 205b receives partition B 204b, and processing system C 205c receives partition C 204c. One of ordinary skill in the art would appreciate that the number of processing systems and the number of partitions illustrated in FIG. 2 is just an example and is not limiting. The number of processing systems and the number of partitions can vary in different embodiments. A processing system receiving a partition may thus see and/or process only a portion of the input data 202.

Each processing system is configured to compute values or confusion matrices for facilitating generating performance metrics for a multi-output, multi-label ML model based upon the partition data received by the processing system for that multi-output, multi-label ML model. Each processing system thus sees and/or processes only a portion of the input data 202 and is able to calculate the values and/or the confusion matrices in partition. In certain implementations, each processing system performs a single pass (a single touch) of the partitioned data and is configured to compute the values for the partition data without storing the data in memory for a second pass of the data. A processing system thus looks at and/or processes a partition only once.

In some embodiments, a processing system is programmed to output a confusion matrix, or a set of calculated values therefrom, for a multi-output, multi-label ML model for the partition provided to the respective processing system. The calculated values may include TP, TN, FP, and FN values, which can be used to calculate performance metrics for the individual classes across all outputs of the multi-output, multi-label ML model, and micro and macro performance metrics computed as described herein. In certain implementations, the outputs from the processing systems are in a form that is serializable and also mergeable with results produced by other processing systems.

In certain implementations, a unique data structure can facilitate computations. The unique data structure enables each processing system to conveniently perform the computations based upon the partition received by the processing system. The data structure also enables the results of those computations to be stored in a form that is serializable and also facilitates merging of results produced, possibly in parallel, by other processing nodes for other partitions for the same multi-output, multi-label ML model.

For example, the data structure may include data variables corresponding to the different metrics, such as data variables for storing TP, TN, FP, and FN values that can be used to generate the different metrics, data variables for different performance metrics for individual classes of a multi-output, multi-label ML model, data variables for micro and macro performance metrics for the model, and the like.

The data structure may also provide methods or functions for performing various operations related to computation of performance metrics for a multi-output, multi-label ML model. Examples of these methods or functions can include methods or functions for computing TP, TN, FP, and FN values based upon the received data, methods or functions for computing different performance metrics for individual classes of a multi-output, multi-label ML model, methods or functions for computing various micro and macro values for a multi-output, multi-label ML model, and the like. The unique data structure may also provide methods or functions for merging two or more data structures and computing merged metrics, metrics for computing the final metrics, and the like. In certain implementations, a special class implementing the data structure may be provided.

For example, and as illustrated in FIG. 2, each of the processing systems outputs a data structure storing the results of confusion matrix-related computations performed by that processing system. As illustrated in FIG. 2, processing system A 205a generates and outputs confusion matrix A 208a, processing system B 205b generates and outputs confusion matrix B 208b, and processing system C 205c generates and outputs confusion matrix C 208c. In some examples, each of the data structures may store a different confusion matrix or values calculated from confusion matrices corresponding to the respective processing system. The “partial” results are then merged to generate a final result.

The merging can happen in one step or via multiple successive merges. For example, and as illustrated in FIG. 2, confusion matrix A 208a and confusion matrix B 208b are first merged by merging system A 207a into merged confusion matrix A+B 210, and then further merged with confusion matrix C 208c by merging system 207b to produce a final merged confusion matrix 206 (e.g., merged confusion matrix (A+B)+C) that can include a single merged confusion matrix and/or values calculated therefrom. The final merged confusion matrix 206 can then be used to calculate the performance metrics for the multi-output, multi-label ML model. The intermediate and final results and the data structures can also be stored for subsequent use. In this manner, the final result for the multi-output, multi-label ML model can be computed for the input data 202 (or the entire stream) without loading the entire stream into memory of a single processing system. In some embodiments, the merging systems and the processing systems may be the same or different from one another.

Due to the partitioning of the input data 202, it is possible that a particular partition received by a particular processing system may not show all the classes associated with the multi-output, multi-label ML model, either in the predicted value or the actual values included in that particular partition. The unique data structure and the mergeable property of the data structure accounts for this. When two results are merged, such as when the confusion matrix for the two results are merged, there is an additive affect to the classes of the outputs. Thus, even if one processing system does not see a particular class (or particular classes), as the partial results are merged, and when the final result is computed from the merging, the final result accounts for all the outputs and their associated classes and is an accurate value for the performance of the multi-output, multi-label ML model. The final result for a multi-output, multi-label ML model includes a final, merged confusion matrix, or micro values and/or macro values calculated therefrom.

There may be different conditions that can trigger the computation of the final result for a multi-output, multi-label ML model. The conditions can, for example, include:
(a) The final result computation is triggered when a certain pre-configured number of data points have been processed. The final results is then based upon those data points.
(b) The final result computation is triggered when a certain pre-configured period of time has lapsed since the computation of the previous final result. The final result is for the data points received in that period of time.
(c) The final result may be computed based upon a schedule.
(d) The final result may be computed on demand. For example, the final result computation may be triggered upon receiving a signal requesting the final result. The request may identify a period of time for which the final result is to be computed. The request may alternatively identify a set of data points (e.g., the last million data points) for which the final result is to be computed. If the period of time, or set of data points is not explicitly identified, then user-configurable default values may be used instead.

In some examples, the final merged confusion matrix 206 can be serialized, such as via serialization 214, and/or that can be provided to the micro/macro calculator 118. In some examples, the micro/macro calculator 118 may read and/or access the final merged confusion matrix 206, or any data thereof, from the serialization 214. The metrics computation system 106 can perform processing on the final merged confusion matrix 206. In some examples, the processing can include determining FN, FP, TN, and TP values, generating micro values and/or macro values for each performance metric, and the like. A result of the processing can include performance metrics 212, which may be or include the micro values and/or the macro values for a particular metric. Additionally or alternatively, the performance metrics 212 may be provided to a training system 220 that can be used to train or otherwise adjust the multi-output, multi-label ML model. For example, the training system 220 can use the performance metrics 212 to adjust training weights of the multi-output, multi-label ML model.

While the various examples described in this disclosure describe using parallel and distributed computation techniques for computation of performance metrics for multi-output, multi-label ML classification models, this is not intended to be limiting. In other embodiments, the algorithms and the teachings described herein can be extended to and used to compute performance metrics for multi-class and multi-label regression models and/or other suitable models.

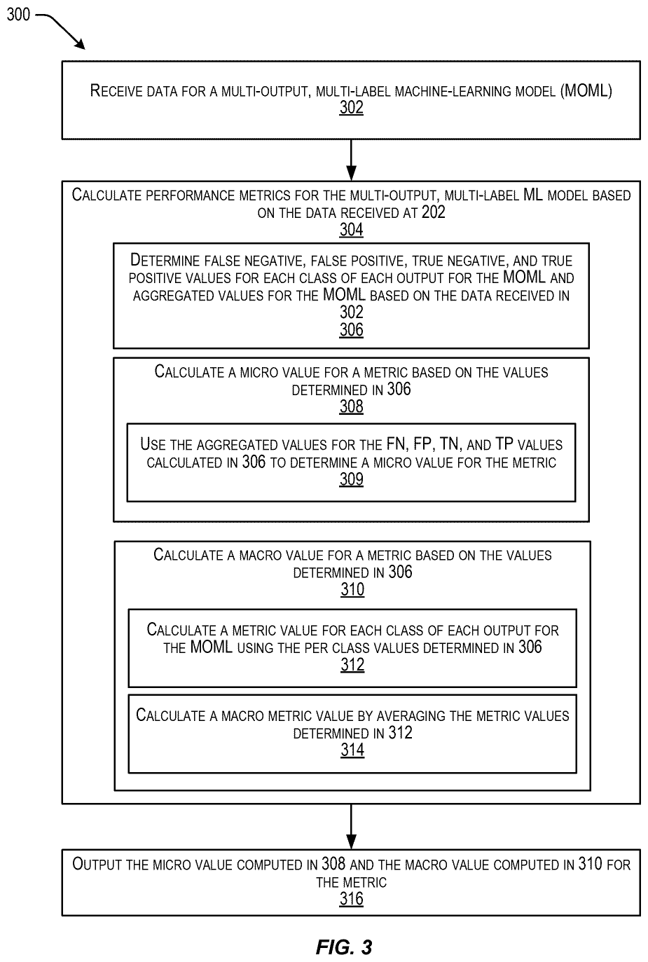

FIG. 3 is a flowchart of a process 300 for computing performance metrics of a multi-output, multi-label ML model, according to at least one embodiment. FIG. 3 depicts a simplified flowchart 300 depicting processing performed for computing performance metrics of a multi-output, multi-label ML model according to certain embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium such as on a memory device. The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 3 may include a greater number or a lesser number of steps than those depicted in FIG. 3. In certain embodiments, such as in the embodiment depicted in FIG. 1, the processing depicted in FIG. 3 may be performed by the multi-output, multi-label ML model 102, the metrics computation system 106, or the like.

At 302, data about a multi-output, multi-label ML model, such as the multi-output, multi-label ML model 102, is received. The received data may include truth data, such as the ground truth 114, may include predictions, such as the predictions 110, from the multi-output, multi-label ML model, and the like. The truth data and the predictions may be based on the same original data. For example, the truth data may be ground truth classifications for the original data, and the predictions may include predictions of classifications for the original data. The multi-output, multi-label ML model may be configured to receive the original data and make the predictions. In some examples, the original data may have or otherwise be associated with a set of outputs, and each output may have or otherwise be associated with a set of classes.

At 304, performance metrics for the multi-output, multi-label ML model are calculated. In some embodiments, the metrics computation system generates the performance metrics by performing one or more operations such as the operations in 306, 308, and 310. The performance metrics may represent a performance of the multi-output, multi-label ML model, may indicate a quality or operation of the multi-output, multi-label ML model, or the like. The performance metrics may be, may include, or may be generated based on the data received at 302 or any calculated values thereof.

At 306, values are calculated for the multi-output, multi-label ML model. The values may be or include false negative values (FN), false positive values (FP), true negative values (TN), and/or true positive values (TP). The values may be calculated for each class of each output of the multi-output, multi-label ML model, may be aggregated for all of the classes, and the like. In some embodiments, a confusion matrix may be used to calculate the values based at least in part on the predictions and the truth data. The confusion matrix may include one or more rows corresponding to true classifications of outputs and one or more columns corresponding to predictions of classifications of the outputs, though a vice versa arrangement, or any other suitable arrangement, is possible. Based on the values of the confusion matrix, the FN, FP, TN, and TP values can be extracted. In some examples, FN, FP, TN, and TP may each be positive or zero integer numbers.

At 308, a micro value for a performance metric can be computed based on the values calculated at 306. In some examples, such as examples in which 308 involves operation 309, aggregated values can be used to compute the micro value for the performance metric. For example, FN, FP, TN, and TP values can each be aggregated for each class of a particular output to generate aggregated values. The aggregated values can be used in a computation that outputs the micro value. For example, the micro value for a precision metric can be (TP/(TP+FP)) in which the TP and FP represent aggregated values for TP and FP.

At 310, a macro value for the particular metric is calculated based on the values calculated at 306. In some embodiments, 310 can involve operations described with respect to 312 and 314 to calculate the macro value for the particular metric. At 312, a metric value can be calculated for each class of each output for the multi-output, multi-label ML model using per-class values for the FN, the FP, the TN, and the TP. Additionally, at 314, the macro value for the particular metric can be calculated by averaging the values determined at 312. In a particular example, a macro precision value can be calculated via an average of (TP/(TP+FP)) in which the TP and FP represent aggregated values for TP and FP. The performance metrics can include a combination of the micro values calculated at 308 and the macro values calculated at 310.

At 316, the performance metrics are output. For example, the performance metrics can be output for controlling the multi-output, multi-label ML model. The performance metrics can be provided to a separate computing device or computing system that can include, access, or otherwise execute the multi-output, multi-label ML model. In some examples, the separate computing device can control the multi-output, multi-label ML model by adjusting training data for the multi-output, multi-label ML model, by adjusting weights within the multi-output, multi-label ML model, or to otherwise update the multi-output, multi-label ML model. Updating the multi-output, multi-label ML model can improve the technical field of machine-learning use and observability. For example, updating multi-output, multi-label ML model can cause the multi-output, multi-label ML model to generate more accurate or more precise predictions, which can yield improved results when using the multi-output, multi-label ML model to make real-world predictions. Additionally, the operations disclosed herein can improve ML observability by providing reliable and accurate metrics for the multi-output, multi-label ML model. Having reliable and accurate metrics for the multi-output, multi-label ML model can allow the separate computing device, or other suitable entity, to make decisions about the multi-output, multi-label ML model, or any data associated therewith, to improve the multi-output, multi-label ML model.

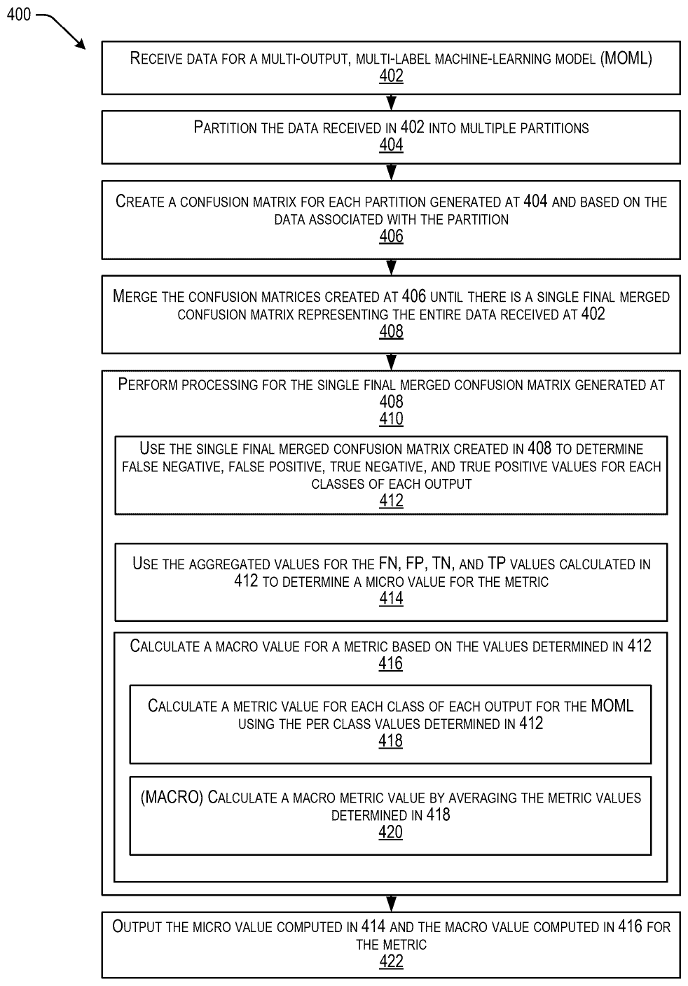

FIG. 4 is a flowchart of a process 400 for computing performance metrics of a multi-output, multi-label ML model using partitioning, according to at least one embodiment. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium such as on a memory device. The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel. It should be appreciated that in alternative embodiments the processing depicted in FIG. 4 may include a greater number or a lesser number of steps than those depicted in FIG. 4. In certain embodiments, such as in the embodiment depicted in FIG. 2, the processing depicted in FIG. 4 may be performed the metrics computation system 106 or other suitable components, services, models, or the like.

At 402, data about a multi-output, multi-label ML model, such as the multi-output, multi-label ML model 102, is received. The received data may include truth data, such as the ground truth 114, may include predictions, such as the predictions 110, from the multi-output, multi-label ML model, and the like. The truth data and the predictions may be based on the same original data. For example, the truth data may be ground truth classifications for the original data, and the predictions may include predictions of classifications for the original data. The multi-output, multi-label ML model may be configured to receive the original data and make the predictions. In some examples, the original data may have or otherwise be associated with a set of outputs, and each output may have or otherwise be associated with a set of classes.

At 404, the data received at 402 is partitioned into a set of partitioned data. The set of partitioned data can be about a multi-output, multi-label ML model, such as the multi-output, multi-label ML model 102. The partitioned set of data may include truth data, such as the ground truth 114, may include predictions, such as the predictions 110, from the multi-output, multi-label ML model, and the like. The truth data and the predictions may be based on the same original data. For example, the truth data may be ground truth classifications for the original data, and the predictions may include predictions of classifications for the original data made by the multi-output, multi-label ML model. Each partition included in the set of partitioned data may include a subset of data from the data received at 402, and the subset of data may include predictions and corresponding truth data.

At 406, a confusion matrix is generated for each partition included in the set of partitioned data. An empty confusion matrix can initially be generated, for example by a respective processing system that receives a particular partition, on a set of outputs indicated by the data received at 402. For example, the data can include data about fruit, and the set of outputs can include different types or classes of fruit. In a specific example, the set of data can include image data about fruit, and the set of outputs can include Apple, Orange, and Mango. The confusion matrix can include a set of rows and a set of columns. The set of rows and the set of columns can correspond to the set of outputs. For example, the set of rows can include an Apple row, an Orange row, and a Mango row, and the set of columns can include an Apple column, an Orange column, and a Mango column. The set of rows can correspond to the truth data, or ground truth, and the set of columns can correspond to the predictions, or vice versa.

To generate the confusion matrix, the metrics computation system, or any other suitable computing device, can populate each row and column with various data. For example, if the first row is Apple truth and the first column is Apple prediction, then row 0, column 0 can represent each time the multi-output, multi-label ML model predicted Apple when the actual class is Apple. Additionally, the other columns can be populated based on the number of times an actual class of the data is Apple and the multi-output, multi-label ML model predicted a different class, and so on.

In some examples, the metrics computation system can receive the set of data as a two-column input. A first column can be a true value, and a second column can be a predicted value. The metrics computation system can generate a set that includes unique elements from both columns, and the set can be encoded with integers. For example, Apple can be encoded as 0, Orange can be encoded as 1, and Mango can be encoded as 2. The empty confusion matrix can be generated with initial values at each location being initialized as 0. For each index in the set of data, the metrics computation system can identify the indices of the confusion matrix to update such as to increase by 1 for each instance. For example, for each instance of a prediction of apple, add 1 to the location of the matrix in the row corresponding to the true value.

At 408, the confusion matrices generated for each partition of the set of partitioned data are merged until a single final merged confusion matrix is generated. Each partition may be transmitted to a different processing system, and the processing system can generate a different confusion matrix based on the received data included in the received partition. The confusion matrices can be transmitted to merging systems that can iteratively merge received confusion matrices until the single final merged confusion matrix is generated.

In some embodiments, a label mapping can be generated for each confusion matrix of the confusion matrices generated by the processing systems. The label mapping can be generated based on the confusion matrix and other confusion matrices generated for other partitions. In some examples, the label mapping can be generated for a merged confusion matrix. That is, the metrics computation system can use the label mapping to merge the confusion matrix with the other confusion matrices. In some examples, the label mapping can be generated by summing the classifications of respective labels from each confusion matrix generated based on each partition of the set of partitioned data. In a particular example, the label mapping can be generated as: new_confusion_matrix[new_label_of_CLASS_A][new_label_of_CLASS_B]=partition_1_confusion_matrix[partition_1_label_of_CLASS_A][partition_1_label_of_CLASS_]+partition_2_confusion_matrix[partition_2_label_of_CLASS_A][partition_2_label_of_CLASS_B].

In some embodiments, the confusion matrices can be merged using the label map. The label map can be used to generate the single final merged confusion matrix. For example, the metrics computation system can apply the label mapping to the generated confusion matrix and other confusion matrices to generate the single final merged confusion matrix.

At 410, processing is performed on the single final merged confusion matrix to calculate performance metrics for the multi-output, multi-label ML model. In some embodiments, the metrics computation system generates the performance metrics by performing one or more operations such as the operations in 412, 414, and 416 with respect to the single final merged confusion matrix. The performance metrics may represent a performance of the multi-output, multi-label ML model, may indicate a quality or operation of the multi-output, multi-label ML model, or the like. The performance metrics may be, may include, or may be generated based on the data received at 402 or any calculated values thereof such as the single final merged confusion matrix.

At 412, values are calculated for the multi-output, multi-label ML model using the single final merged confusion matrix. The values may be or include false negative values (FN), false positive values (FP), true negative values (TN), and/or true positive values (TP). The values may be calculated for each class of each output indicated by the single final merged confusion matrix, may be aggregated for all of the classes, and the like. In some embodiments, and based on the values of the single final merged confusion matrix, the FN, FP, TN, and TP values can be extracted. In some examples, FN, FP, TN, and TP may each be positive or zero integer numbers.

At 414, a micro value for a performance metric can be computed based on the values calculated at 412. In some examples, aggregated values can be used to compute the micro value for the performance metric. For example, FN, FP, TN, and TP values can each be aggregated for each class of a particular output to generate aggregated values. The aggregated values can be used in a computation that outputs the micro value. For example, the micro value for a precision metric can be (TP/(TP+FP)) in which the TP and FP represent aggregated values for TP and FP.

At 416, a macro value for the particular metric is calculated based on the values calculated at 412. In some embodiments, 416 can involve operations described with respect to 418 and 420 to calculate the macro value for the particular metric. At 418, a metric value can be calculated for each class of each output for the multi-output, multi-label ML model using per-class values for the FN, the FP, the TN, and the TP. Additionally, at 420, the macro value for the particular metric can be calculated by averaging the values determined at 418. In a particular example, a macro precision value can be calculated via an average of (TP/(TP+FP)) in which the TP and FP represent aggregated values for TP and FP. The performance metrics can include a combination of the micro values calculated at 414 and the macro values calculated at 416.

At 422, the performance metrics are output. For example, the performance metrics can be output for controlling the multi-output, multi-label ML model. The performance metrics can be provided to a separate computing device or computing system that can include, access, or otherwise execute the multi-output, multi-label ML model. In some examples, the separate computing device can control the multi-output, multi-label ML model by adjusting training data for the multi-output, multi-label ML model, by adjusting weights within the multi-output, multi-label ML model, or to otherwise update the multi-output, multi-label ML model. Updating the multi-output, multi-label ML model can improve the technical field of machine-learning use and observability. For example, updating multi-output, multi-label ML model can cause the multi-output, multi-label ML model to generate more accurate or more precise predictions, which can yield improved results when using the multi-output, multi-label ML model to make real-world predictions. Additionally, the operations disclosed herein can improve ML observability by providing reliable and accurate metrics for the multi-output, multi-label ML model. Having reliable and accurate metrics for the multi-output, multi-label ML model can allow the separate computing device, or other suitable entity, to make decisions about the multi-output, multi-label ML model, or any data associated therewith, to improve the multi-output, multi-label ML model.

### Exemplary Embodiment

In some examples, a multi-output, multi-label ML model is trained to produce two labels, or outputs, for an input data point: (1) a Level_of_Horror label, and (2) a Rating label. The input data point may, for example, be data representing a movie. The classification for a Level_of_Horror label can be selected from a set of classes {“low”, “med”, “high”}, and the classification for a Rating label can be selected from a set of classes {“3”, “4”, “5”}. Thus,
Level_of_Horror={“low”, “med”, “high”}
Rating={“3”, “4”, “5”}

For some example input data points, TABLE 2, produced below, illustrates for each data point the predicted values and the truth values for the Level_of_Horror and Rating labels:

TABLE 2

| | Level_of_Horror | Level_of_Horror | Rating | Rating |
|---|---|---|---|---|
| Input Data | (predicted | (true | (predicted | (true |
| Point | value) | value) | value) | value) |
| #1 | low | low | 3 | 4 |
| #2 | med | low | 4 | 5 |
| #3 | high | high | 5 | 3 |
| #4 | low | med | 4 | 4 |
| #5 | med | high | 4 | 5 |
| #6 | high | low | 5 | 3 |

Based upon the above predicted and true values for each of the labels for the data points, the various values in the table shown below (TABLE 3) can be computed.

TABLE 3

| | | | | | Precision/ | Recall/class = | Accuracy/class = |
|---|---|---|---|---|---|---|---|
| Labels/ | | | | | class = | TP/ | (TP +TN)/ |
| Metrics | TP | FP | FN | TN | TP/(TP + FP) | (TP + FN) | (TP + FP + FN + TN) |
| Horror = high | 1 | 1 | 1 | 3 | 1/(1 + 1) = 0.5 | 1/(1 + 1) = 0.5 | (1 + 3)/ |
| | | | | | | | (1 + 1 + 1 + 3) = 0.667 |
| Horror = low | 1 | 1 | 2 | 2 | 1/(1 + 1) = 0.5 | 1/(1 + 2) = | (1 + 2)/ |
| | | | | | | 0.33 | (1 + 1 + 2 + 2) = 0.5 |
| Horror = med | 0 | 2 | 1 | 3 | 0 | 0 | (0 + 3)/ |
| | | | | | | | (0 + 2 + 1 + 3) = 0.5 |
| Rating = 3 | 0 | 1 | 2 | 3 | 0 | 0 | (0 + 3)/ |
| | | | | | | | (0 + 1 + 2 + 3) = 0.5 |
| Rating = 4 | 1 | 2 | 1 | 2 | 1/(1 + 2) = | 1/(1 + 1) = 0.5 | (1 + 2)/ |
| | | | | | 0.333 | | (1 + 2 + 1 + 2) = 0.5 |
| Rating = 5 | 0 | 2 | 2 | 2 | 0 | 0 | (0 + 2)/ |
| Total | 3 | 9 | 9 | 15 | | | (0 + 2 + 2 + 2) = 0.333 |

In certain implementations, confusion matrices may be generated for the different labels based upon the values shown in TABLE 2. A confusion matrix may be constructed for each label. Accordingly, for the “Level_of_Horror” and “Rating” labels example, there would be two confusion matrices, one for the Level_of_Horror label and another for the Rating label. For example, for the data shown in Table 2, the confusion matrix for “Level_of_Horror” label may look as follows:

Confusion Matrix for Level_of_Horror Label

| | | | | |
|---|---|---|---|---|
| TRUE | low | 1 | 1 | 1 |
| Horror | med | 1 | 0 | 0 |
| Labels | high | 0 | 1 | 1 |
| | | low | med | high |

PREDICTED Horror Label values

For the data shown in Table 2, the confusion matrix for “Rating” label may look as follows:

Confusion Matrix for Rating Label

| | | | | |
|---|---|---|---|---|
| TRUE | “3” | 0 | 0 | 2 |
| Rating | “4” | 1 | 1 | 0 |
| Labels | “5” | 0 | 2 | 0 |
| | | “3” | “4” | “5” |

PREDICTED Rating Label values

The confusion matrices, such as the ones produced above, can then be used to determine the true positive (TP), true negative (TN), false positive (FP), and false negative (FN) values for all the classes associated with the multi-output, multi-label ML model (e.g., for each class of each of the labels of the multi-output, multi-label ML model). The computed values are generated based on the confusion matrices and are produced in TABLE 3. The TP, TN, FP, and FN values are then used to calculate different performance metrics for each class of each of the labels of the multi-output, multi-label ML model. For example, in TABLE 3, precision, recall, and accuracy metrics are computed for each of Horror-low, Horror-mid, Horror-high, Rating-3, Rating-4, and Rating-5 classes associated with the multi-output, multilabel ML model. While the uses of confusion matrices has been described herein, this is not intended to be limiting. Other techniques may be used for computing values for TP, TN, FP, and FN in other embodiments.

The values in TABLE 3 are then used to determine macro averages and/or micro averages for performance metrics for the multi-output, multi-label ML model. For example, and based upon TABLE 3, micro averages and macro averages for performance metrics are computed for the multi-output, multi-label ML model as produced in TABLE 4 below. For a performance metric (e.g., precision), a micro average or value (e.g., precision micro value) is calculated for the performance metrics, and another macro average or value (e.g., precision macro value) is computed for the performance metric for the multi-output, multi-label ML model. In this manner, a micro value and a macro value may be computed for each performance metric of the performance metrics to be calculated for the multi-output, multi-label ML model.

TABLE 4 is produced below and illustrates the computation of macro values and micro values for three possible performance metrics for the multi-output, multi-label ML model, namely, precision, recall, and accuracy.

TABLE 4

| Metric | Value |
|---|---|
| Precision Macro | (0.5 + 0.5 + 0 + 0 + 0.33 + 0)/6 = 0.222 |
| Precision Micro | 3/(3 + 9) = 0.25 |
| Recall Macro | (0.5 + 0.33 + 0 + 0 + 0.2 + 0)/6 = 0.172 |
| Recall Micro | 3/(3 + 9) = 0.25 |
| Accuracy Macro | (0.667 + 0.5 + 0.5 + 0.5 + 0.5 + 0.333)/6 = 0.5 |
| Accuracy Micro | (3 + 15)43 + 9 + 9 + 15) = 0.5 |

In certain implementations, a value for a macro performance metric (e.g., precision macro) for the multi-output, multi-label ML model is computed by aggregating the performance metric values computed for each of the classes of the labels and dividing the aggregate by the total number of classes. In the above example, the total number of classes associated with the multi-output, multi-label ML model is six, with the classes being Horror-low, Horror-mid, Horror-high, Rating-3, Rating-4, and Rating-5. For computing a macro precision metric value for the multi-output, multi-label ML model, the precision metric values computed for each of these six classes are added and the sum divided by six, as illustrated in the first row of TABLE 4, to get a value of 0.222. Other macro performance metrics are computed in a similar manner.

In certain implementations, a value for a micro performance metric (e.g., precision micro) for the multi-output, multi-label ML model is computed based upon the TP, TN, FP, and FN values computed for the individual classes for the multiple labels of the multi-output, multi-label ML model. For example, the formula for computing a precision metric is (TP/(TP+FP)). Accordingly, for calculating the micro precision metric, the aggregate TP and FP values are first determined based upon the TP and FP values computed for the individual classes of the multi-output, multi-label ML model. The aggregate TP value is the sum of all the TP values computed for the classes of the multi-output, multi-label ML model. In the example in TABLE 3, it is the sum of the TP values in column 2 of Table 3, which add up to a value of 3. Likewise, the aggregate FP value is the sum of all the FP values computed for the classes of the multi-output, multi-label ML model. In the example in TABLE 3, it is the sum of the FP values in column 3 of TABLE 3, which add up to a value of 9. The micro precision metric for the multi-output, multi-label ML model is then computed using the formula (TP/(TP+FP))=(3/(3+9))=0.25, illustrated in the second row of TABLE 4. Other micro performance metrics are computed in a similar manner.

### Example of Pseudocode for an Algorithm

PSEUDOCODE FOR MULTILABEL MULTICLASS
CLASSIFICATION METRICS

```
Consider a classification model which predicts M outputs ->
O1, O2, ...OM, and each output have N1,N2,N2...classes.
That data is captured in multiple partitions, let P1, P2,...,Pn be
the partitions.
Each partition may include the following column:
1. Target column for each output, O1_true, O2_true, .... Om_true.
2. Prediction column for eacg output.
O1_predict, O2_predict, .... Om_predict.
INITIALISATION:
CONFUSION_MATRICES = CREATE M confusion matrices,
one per output.
COMPUTE:
Input:Pk, kth partition,
for each output Oi:
  unique_classes = set(Oi_true, Oi_predict)
  dimension_oi = size(unique_classes)
  Populate the CONFUSION_MATRIX using the matching value
MERGE:
INPUT: Pi : ith Partition, Pj: jth Partition:
for each output Oi:
  Merge the confusion taking into account the following:
    - Merge the labels
    - Merge the count for each labels.
GET_RESULT:
We have M confusion matrices per output.
  TPS = [ ]
  FPs = [ ]
  FNs = [ ]
  TNs = [ ]
for each confusion matrix Oi:
  calculate tp, fp, fn to per class for confusion matric oi.
    Add each of the above to TPs, FPs, FNs, TNs respectively.
MICRO_MICRO_PRECISION = TPs.sum( ) / (TPs.sum( ) +
FPs.sum( ))
MICRO_MICRO_RECALL = TPs.sum( ) / (TPs.sum( ) +
FNs.sum( ))
MICRO_MICRO_ACCURACY = (TPs.sum( ) + TNs. sum( )) /
(TPs.sum( ) + FPs.sum( ) + TNs.sum( ) + FNs.sum( ))
MACRO_MACRO_PRECISION = AVERAGE (TPs / (TPs + FPs) )
MACRO_MACRO_RECALL = AVERAGE ( TPs / (TPs + FNs) )
MACRO_MACRO_ACCURACY = AVERAGE ( (TPs + TNs) /
(TPs + FPs + TNs + FNs) )
```

### Examples of Architectures for Implementing Cloud Infrastructures

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed may need to be set up first. In some instances, the provisioning can be done manually, a provisioning tool may be utilized to provision the resources, and/or deployment tools may be utilized to deploy the code once the infrastructure is provisioned.

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively coupled to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Metadata that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 554, which may not have a desired level of threat prevention, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

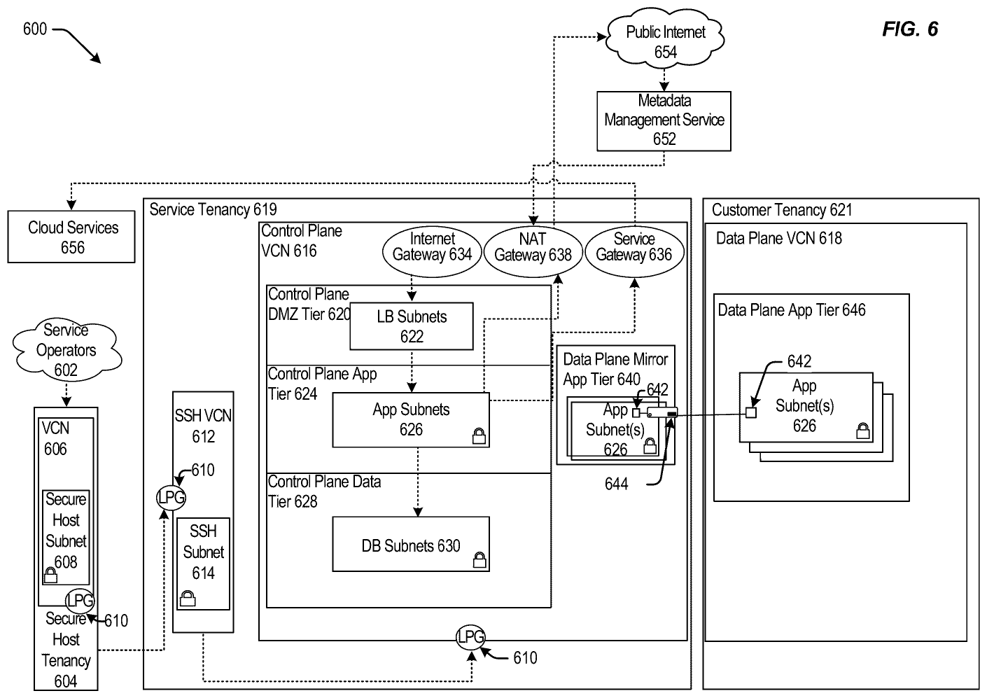

FIG. 6 is a block diagram 600 illustrating another example pattern of an IaaS architecture, according to at least one embodiment. Service operators 602 (e.g., service operators 502 of FIG. 5) can be communicatively coupled to a secure host tenancy 604 (e.g., the secure host tenancy 504 of FIG. 5) that can include a virtual cloud network (VCN) 606 (e.g., the VCN 506 of FIG. 5) and a secure host subnet 608 (e.g., the secure host subnet 508 of FIG. 5). The VCN 606 can include a local peering gateway (LPG) 610 (e.g., the LPG 510 of FIG. 5) that can be communicatively coupled to a secure shell (SSH) VCN 612 (e.g., the SSH VCN 512 of FIG. 5) via an LPG 510 contained in the SSH VCN 612. The SSH VCN 612 can include an SSH subnet 614 (e.g., the SSH subnet 514 of FIG. 5), and the SSH VCN 612 can be communicatively coupled to a control plane VCN 616 (e.g., the control plane VCN 516 of FIG. 5) via an LPG 610 contained in the control plane VCN 616. The control plane VCN 616 can be contained in a service tenancy 619 (e.g., the service tenancy 519 of FIG. 5), and the data plane VCN 618 (e.g., the data plane VCN 518 of FIG. 5) can be contained in a customer tenancy 621 that may be owned or operated by users, or customers, of the system.

The control plane VCN 616 can include a control plane DMZ tier 620 (e.g., the control plane DMZ tier 520 of FIG. 5) that can include LB subnet(s) 622 (e.g., LB subnet(s) 522 of FIG. 5), a control plane app tier 624 (e.g., the control plane app tier 524 of FIG. 5) that can include app subnet(s) 626 (e.g., app subnet(s) 526 of FIG. 5), a control plane data tier 628 (e.g., the control plane data tier 528 of FIG. 5) that can include database (DB) subnet(s) 630 (e.g., similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g., the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g., the service gateway 536 of FIG. 5) and a network address translation (NAT) gateway 638 (e.g., the NAT gateway 538 of FIG. 5). The control plane VCN 616 can include the service gateway 636 and the NAT gateway 638.

The control plane VCN 616 can include a data plane mirror app tier 640 (e.g., the data plane mirror app tier 540 of FIG. 5) that can include app subnet(s) 626. The app subnet(s) 626 contained in the data plane mirror app tier 640 can include a virtual network interface controller (VNIC) 642 (e.g., the VNIC of 542) that can execute a compute instance 644 (e.g., similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g., the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g., the metadata management service 552 of FIG. 5) that can be communicatively coupled to public Internet 654 (e.g., public Internet 554 of FIG. 5). Public Internet 654 can be communicatively coupled to the NAT gateway 638 contained in the control plane VCN 616. The service gateway 636 contained in the control plane VCN 616 can be communicatively coupled to cloud services 656 (e.g., cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 5,” may be located in Region 1 and in “Region 2.” If a call to Deployment 5 is made by the service gateway 636 contained in the control plane VCN 616 located in Region 1, the call may be transmitted to Deployment 5 in Region 1. In this example, the control plane VCN 616, or Deployment 5 in Region 1, may not be communicatively coupled to, or otherwise in communication with, Deployment 5 in Region 2.

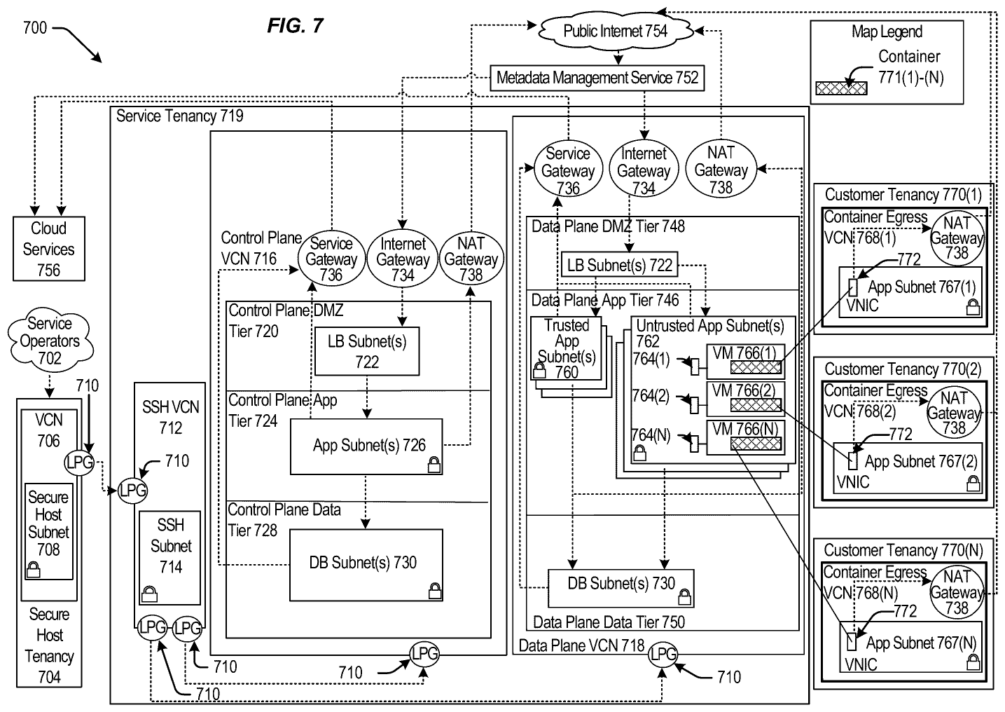

FIG. 7 is a block diagram 700 illustrating another example pattern of an IaaS architecture, according to at least one embodiment. Service operators 702 (e.g., service operators 502 of FIG. 5) can be communicatively coupled to a secure host tenancy 704 (e.g., the secure host tenancy 504 of FIG. 5) that can include a virtual cloud network (VCN) 706 (e.g., the VCN 506 of FIG. 5) and a secure host subnet 708 (e.g., the secure host subnet 508 of FIG. 5). The VCN 706 can include an LPG 710 (e.g., the LPG 510 of FIG. 5) that can be communicatively coupled to an SSH VCN 712 (e.g., the SSH VCN 512 of FIG. 5) via an LPG 710 contained in the SSH VCN 712. The SSH VCN 712 can include an SSH subnet 714 (e.g., the SSH subnet 514 of FIG. 5), and the SSH VCN 712 can be communicatively coupled to a control plane VCN 716 (e.g., the control plane VCN 516 of FIG. 5) via an LPG 710 contained in the control plane VCN 716 and to a data plane VCN 718 (e.g., the data plane 518 of FIG. 5) via an LPG 710 contained in the data plane VCN 718. The control plane VCN 716 and the data plane VCN 718 can be contained in a service tenancy 719 (e.g., the service tenancy 519 of FIG. 5).

The control plane VCN 716 can include a control plane DMZ tier 720 (e.g., the control plane DMZ tier 520 of FIG. 5) that can include load balancer (LB) subnet(s) 722 (e.g., LB subnet(s) 522 of FIG. 5), a control plane app tier 724 (e.g., the control plane app tier 524 of FIG. 5) that can include app subnet(s) 726 (e.g., similar to app subnet(s) 526 of FIG. 5), a control plane data tier 728 (e.g., the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g., the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g., the service gateway of FIG. 5) and a network address translation (NAT) gateway 738 (e.g., the NAT gateway 538 of FIG. 5). The control plane VCN 716 can include the service gateway 736 and the NAT gateway 738.

The data plane VCN 718 can include a data plane app tier 746 (e.g., the data plane app tier 546 of FIG. 5), a data plane DMZ tier 748 (e.g., the data plane DMZ tier 548 of FIG. 5), and a data plane data tier 750 (e.g., the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g., public Internet 554 of FIG. 5).

The Internet gateway 734 contained in the control plane VCN 716 and contained in the data plane VCN 718 can be communicatively coupled to a metadata management service 752 (e.g., the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively coupled to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

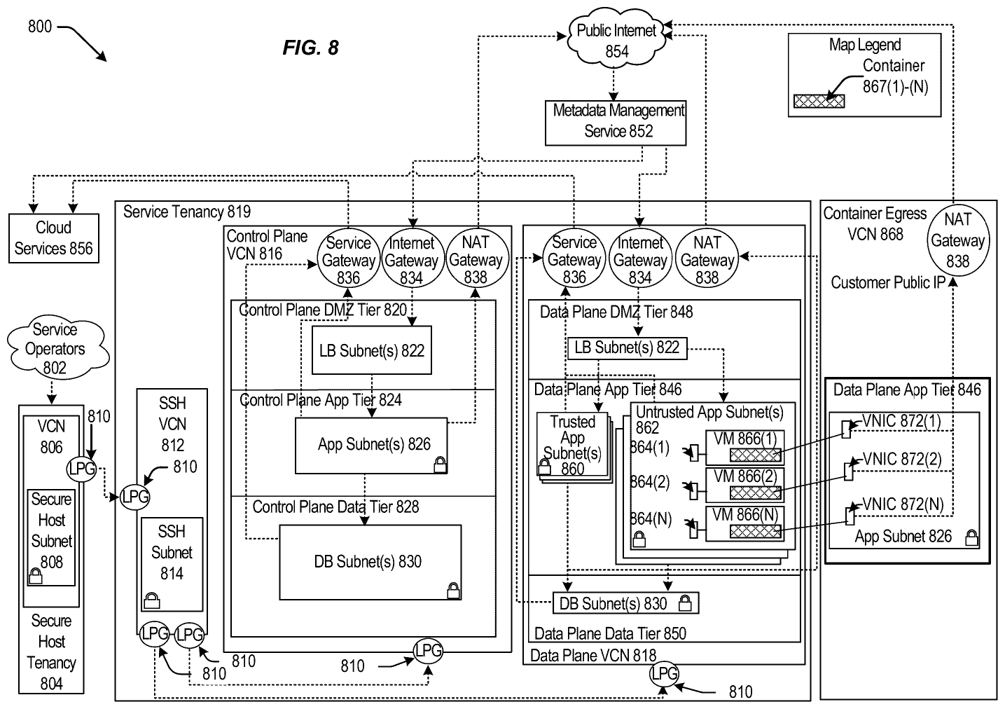

FIG. 8 is a block diagram 800 illustrating another example pattern of an IaaS architecture, according to at least one embodiment. Service operators 802 (e.g., service operators 502 of FIG. 5) can be communicatively coupled to a secure host tenancy 804 (e.g., the secure host tenancy 504 of FIG. 5) that can include a virtual cloud network (VCN) 806 (e.g., the VCN 506 of FIG. 5) and a secure host subnet 808 (e.g., the secure host subnet 508 of FIG. 5). The VCN 806 can include an LPG 810 (e.g., the LPG 510 of FIG. 5) that can be communicatively coupled to an SSH VCN 812 (e.g., the SSH VCN 512 of FIG. 5) via an LPG 810 contained in the SSH VCN 812. The SSH VCN 812 can include an SSH subnet 814 (e.g., the SSH subnet 514 of FIG. 5), and the SSH VCN 812 can be communicatively coupled to a control plane VCN 816 (e.g., the control plane VCN 516 of FIG. 5) via an LPG 810 contained in the control plane VCN 816 and to a data plane VCN 818 (e.g., the data plane 518 of FIG. 5) via an LPG 810 contained in the data plane VCN 818. The control plane VCN 816 and the data plane VCN 818 can be contained in a service tenancy 819 (e.g., the service tenancy 519 of FIG. 5).

The control plane VCN 816 can include a control plane DMZ tier 820 (e.g., the control plane DMZ tier 520 of FIG. 5) that can include LB subnet(s) 822 (e.g., LB subnet(s) 522 of FIG. 5), a control plane app tier 824 (e.g., the control plane app tier 524 of FIG. 5) that can include app subnet(s) 826 (e.g., app subnet(s) 526 of FIG. 5), a control plane data tier 828 (e.g., the control plane data tier 528 of FIG. 5) that can include DB subnet(s) 830 (e.g., DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g., the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g., the service gateway of FIG. 5) and a network address translation (NAT) gateway 838 (e.g., the NAT gateway 538 of FIG. 5). The control plane VCN 816 can include the service gateway 836 and the NAT gateway 838.

The data plane VCN 818 can include a data plane app tier 846 (e.g., the data plane app tier 546 of FIG. 5), a data plane DMZ tier 848 (e.g., the data plane DMZ tier 548 of FIG. 5), and a data plane data tier 850 (e.g., the data plane data tier 550 of FIG. 5). The data plane DMZ tier 848 can include LB subnet(s) 822 that can be communicatively coupled to trusted app subnet(s) 860 (e.g., trusted app subnet(s) 760 of FIG. 7) and untrusted app subnet(s) 862 (e.g., untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g., public Internet 554 of FIG. 5).

The Internet gateway 834 contained in the control plane VCN 816 and contained in the data plane VCN 818 can be communicatively coupled to a metadata management service 852 (e.g., the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively coupled to cloud services 856.

In some examples, the pattern illustrated by the architecture of block diagram 800 of FIG. 8 may be considered an exception to the pattern illustrated by the architecture of block diagram 700 of FIG. 7 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### Example of a Computer System or Device

FIG. 9 illustrates an example computer system 900, in which various embodiments may be implemented. The system 900 may be used to implement any of the computer systems and processing systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some, or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 904 provide the functionality described above. Storage subsystem 918 may also provide a repository for storing data used in accordance with the present disclosure.

As depicted in the example in FIG. 9, storage subsystem 918 can include various components including a system memory 910, computer-readable storage media 922, and a computer readable storage media reader 920. System memory 910 may store program instructions that are loadable and executable by processing unit 904. System memory 910 may also store data that is used during the execution of the instructions and/or data that is generated during the execution of the program instructions. Various different kinds of programs may be loaded into system memory 910 including but not limited to client applications, Web browsers, mid-tier applications, relational database management systems (RDBMS), virtual machines, containers, etc.

System memory 910 may also store an operating system 916. Examples of operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 900 executes one or more virtual machines, the virtual machines along with their guest operating systems (GOSs) may be loaded into system memory 910 and executed by one or more processors or cores of processing unit 904.

System memory 910 can come in different configurations depending upon the type of computer system 900. For example, system memory 910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 910 may include a basic input/output system (BIOS) containing basic routines that help to transfer information between elements within computer system 900, such as during start-up.

Computer-readable storage media 922 may represent remote, local, fixed, and/or removable storage devices plus storage media for temporarily and/or more permanently containing, storing, computer-readable information for use by computer system 900 including instructions executable by processing unit 904 of computer system 900.

Computer-readable storage media 922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Machine-readable instructions executable by one or more processors or cores of processing unit 904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 924 provides an interface to other computer systems and networks. Communications subsystem 924 serves as an interface for receiving data from and transmitting data to other systems from computer system 900. For example, communications subsystem 924 may enable computer system 900 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments provides an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A computer-implemented method comprising:
receiving data about a multi-output, multi-label machine-learning (ML) model, the data comprising predictions made by the multi-output, multi-label ML model and truth data associated with the predictions, the truth data comprising information about a ground truth of corresponding predictions of the predictions;
determining, for each class and each output of the predictions of the multi-output multi-label ML model and based on the truth data, false negative values (FN), false positive values (FP), true negative values (TN), and true positive values (TP);
generating a micro value for a performance metric based on aggregated values associated with the FN, the FP, the TN, and the TP;
generating a macro value for the performance metric based on averaged values of the FN, the FP, the TN, and the TP; and
outputting the performance metric for controlling the multi-output, multi-label ML model based at least in part upon the performance metrics.

2. The computer-implemented method of claim 1, wherein the predictions comprise a plurality of outputs, wherein, for each output included in the plurality of outputs, the multi-output, multi-label ML model selects a class prediction for the output from a plurality of classes associated with the output, and wherein the plurality of classes for an output included in the plurality of outputs is different from a plurality of classes associated with one or more other outputs included in the plurality of outputs.

3. The computer-implemented method of claim 2, wherein receiving the data about the multi-output, multi-label ML model comprises:
receiving data for each of a plurality of datapoints, wherein the data for each datapoint included in the plurality of datapoints comprises:
information included in the predictions and identifying a class predicted by the multi-output, multi-label ML model for each output included the plurality of outputs; and
information included in the truth data and identifying a ground truth class for each output included the plurality of outputs; and
partitioning the received data.

4. The computer-implemented method of claim 3, wherein partitioning the received data comprises:
partitioning the data received for the multi-output, multi-label ML model into at least a first partition and a second partition, the first partition comprising data for a first set of datapoints from the plurality of datapoints and the second partition comprising data for a second set of datapoints from the plurality of datapoints;
computing, by a first processing system, a first confusion matrix and a first set of values based upon the first partition received by the first processing system;
computing, by a second processing system, a second confusion matrix and a second set of values based upon the second partition received by the second processing system; and
generating a merged confusion matrix by merging the first confusion matrix and the second confusion matrix.

5. The computer-implemented method of claim 4, further comprising using the merged confusion matrix to determine the FN, the FP, the TN, and the TP for each output and for each class.

6. The computer-implemented method of claim 4, wherein at least a portion of the computing performed by the second processing system is performed substantially contemporaneously with respect to the computing performed by the first processing system.

7. The computer-implemented method of claim 1, wherein:
generating the micro value comprises calculating the micro value for the metric by aggregating, by class, the FN, the FP, the TN, and the TP; and
generating the macro value comprises (i) calculating metric values for each class of each output using the FN, the FP, the TN, and the TP and (ii) averaging the metric values.

8. A system comprising:
one or more processors; and
a memory coupled to the one or more processors, the memory storing a plurality of instructions executable by the one or more processors, the plurality of instructions comprising instructions executable by the one or more processors to cause the one or more processors to perform operations comprising:
receiving data about a multi-output, multi-label machine-learning (ML) model, the data comprising predictions made by the multi-output, multi-label ML model and truth data associated with the predictions, the truth data comprising information about a ground truth of corresponding predictions of the predictions;
determining, for each class and each output of the predictions of the multi-output multi-label ML model and based on the truth data, false negative values (FN), false positive values (FP), true negative values (TN), and true positive values (TP);
generating a micro value for a performance metric based on aggregated values associated with the FN, the FP, the TN, and the TP;
generating a macro value for the performance metric based on averaged values of the FN, the FP, the TN, and the TP; and
outputting the performance metric for controlling the multi-output, multi-label ML model based at least in part upon the performance metrics.

9. The system of claim 8, wherein the predictions comprise a plurality of outputs, wherein, for each output included in the plurality of outputs, the multi-output, multi-label ML model selects a class prediction for the output from a plurality of classes associated with the output, and wherein the plurality of classes for an output included in the plurality of outputs is different from a plurality of classes associated with one or more other outputs included in the plurality of outputs.

10. The system of claim 9, wherein receiving the data about the multi-output, multi-label ML model comprises:
receiving data for each of a plurality of datapoints, wherein the data for each datapoint included in the plurality of datapoints comprises:
information included in the predictions and identifying a class predicted by the multi-output, multi-label ML model for each output included the plurality of outputs; and
information included in the truth data and identifying a ground truth class for each output included the plurality of outputs; and
partitioning the received data.

11. The system of claim 10, wherein the operation of partitioning the received data comprises:
partitioning the data received for the multi-output, multi-label ML model into at least a first partition and a second partition, the first partition comprising data for a first set of datapoints from the plurality of datapoints and the second partition comprising data for a second set of datapoints from the plurality of datapoints;
computing, by a first processing system, a first confusion matrix and a first set of values based upon the first partition received by the first processing system;
computing, by a second processing system, a second confusion matrix and a second set of values based upon the second partition received by the second processing system; and
generating a merged confusion matrix by merging the first confusion matrix and the second confusion matrix.

12. The system of claim 11, wherein the operations further comprise using the merged confusion matrix to determine the FN, the FP, the TN, and the TP for each output and for each class.

13. The system of claim 11, wherein at least a portion of the computing performed by the second processing system is performable substantially contemporaneously with respect to the computing performed by the first processing system.

14. The system of claim 9, wherein:
the operation of generating the micro value comprises calculating the micro value for the metric by aggregating, by class, the FN, the FP, the TN, and the TP; and
the operation generating the macro value comprises (i) calculating metric values for each class of each output using the FN, the FP, the TN, and the TP and (ii) averaging the metric values.

15. A non-transitory computer-readable memory storing a plurality of instructions executable by one or more processors, the plurality of instructions comprising instructions that, when executed by the one or more processors, cause the one or more processors to perform operations, comprising:
receiving data about a multi-output, multi-label machine-learning (ML) model, the data comprising predictions made by the multi-output, multi-label ML model and truth data associated with the predictions, the truth data comprising information about a ground truth of corresponding predictions of the predictions;
determining, for each class and each output of the predictions of the multi-output multi-label ML model and based on the truth data, false negative values (FN), false positive values (FP), true negative values (TN), and true positive values (TP);
generating a micro value for a performance metric based on aggregated values associated with the FN, the FP, the TN, and the TP;
generating a macro value for the performance metric based on averaged values of the FN, the FP, the TN, and the TP; and
outputting the performance metric for controlling the multi-output, multi-label ML model based at least in part upon the performance metrics.

16. The non-transitory computer-readable memory of claim 15, wherein the predictions comprise a plurality of outputs, wherein, for each output included in the plurality of outputs, the multi-output, multi-label ML model selects a class prediction for the output from a plurality of classes associated with the output, and wherein the plurality of classes for an output included in the plurality of outputs is different from a plurality of classes associated with one or more other outputs included in the plurality of outputs.

17. The non-transitory computer-readable memory of claim 16, wherein receiving the data about the multi-output, multi-label ML model comprises:
receiving data for each of a plurality of datapoints, wherein the data for each datapoint included in the plurality of datapoints comprises:
information included in the predictions and identifying a class predicted by the multi-output, multi-label ML model for each output included the plurality of outputs; and
information included in the truth data and identifying a ground truth class for each output included the plurality of outputs; and
partitioning the received data.

18. The non-transitory computer-readable memory of claim 17, wherein the operation of partitioning the received data comprises:
partitioning the data received for the multi-output, multi-label ML model into at least a first partition and a second partition, the first partition comprising data for a first set of datapoints from the plurality of datapoints and the second partition comprising data for a second set of datapoints from the plurality of datapoints;
computing, by a first processing system, a first confusion matrix and a first set of values based upon the first partition received by the first processing system;
computing, by a second processing system, a second confusion matrix and a second set of values based upon the second partition received by the second processing system; and
generating a merged confusion matrix by merging the first confusion matrix and the second confusion matrix.

19. The non-transitory computer-readable memory of claim 18, wherein the operations further comprise using the merged confusion matrix to determine the FN, the FP, the TN, and the TP for each output and for each class, and wherein at least a portion of the computing performed by the second processing system is performable substantially contemporaneously with respect to the computing performed by the first processing system.

20. The non-transitory computer-readable memory of claim 16, wherein:
the operation of generating the micro value comprises calculating the micro value for the metric by aggregating, by class, the FN, the FP, the TN, and the TP; and
the operation generating the macro value comprises (i) calculating metric values for each class of each output using the FN, the FP, the TN, and the TP and (ii) averaging the metric values.
